(19) United States
(12) Patent Application Publication
(10) Pub. No.: US 2004/0241443 A1
(43) Pub. Date: Dec. 2, 2004

(54) Heat resistant powder coating composition having enhanced properties

(76) Inventors: Owen H. Decker, Houston, TX (US); Wenjing Zhou, Houston, TX (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/780,392

(22) Filed: Feb. 17, 2004

Related U.S. Application Data
(60) Provisional application No. 60/449,275, filed on Feb. 21, 2003.

(51) Int. Cl. B32B 9/00

(52) U.S. Cl. 428/402; 428/323; 428/447

(57) ABSTRACT

A thermosetting, heat-resistant, silicon based powder coating composition is provided for use on substrates likely to be subjected to high temperatures above 550° C. The powder coating composition contains low melting glass particles, which soften and flow at temperatures in the range which the organic components of the coating burn away. The glass particles at such temperatures are therefore able to fill voids in the film formed from the coating powders and prevent adhesion failure of the coating from the substrate.

### CROSS-REFERENCE TO RELATED APPLICATION

This application claims priority under 35 U.S.C. §119 from U.S. Provisional Application Ser. No. 60/449,275 (filed Feb. 21, 2003), which is incorporated by reference herein as if fully set forth.

### FIELD OF THE INVENTION

The present invention relates to a thermosetting heat-resistant powder coating composition. Specifically, the present composition provides a coating that can be generally applied to articles which are likely to be subjected to elevated temperatures, which coating is resistant to adhesive failure from the article.

### BACKGROUND OF THE INVENTION

Powder coating compositions which provide high heat resistance have been under development for many years. It is known that powder coatings incorporating polysiloxane resins have high heat resistance. For example, Eklund et al U.S. Pat. No. 5,905,104 issued May 18, 1999 describes polysiloxane coating powders which produce coatings that withstand high temperatures. While there have been various polysiloxane based powder coating compositions proposed over the years, there is still one major drawback with such coatings that has been difficult to solve. When conventional thermoset polysiloxane powder coated materials are exposed to temperatures of 550° C. (1022° F.) or upward including red hot conditions, the coatings suffer loss of their organic components and undergo rapid shrinkage and embrittlement, causing them to readily crack and peel from the substrate or flake off the substrate. Various attempts have been made to solve this problem through incorporation of organic functional groups, such as organic acid groups, into the polysiloxane resin, or adhesion promoters and/or reinforcing fillers into the coating, with only limited success. For high temperature applications, such as automotive exhaust parts, barbeque grills, stove burners, or the like, coating powders are desired which produce coatings that can withstand even higher temperatures.

The novel powder coating composition of this invention has the aforementioned desirable characteristic.

### SUMMARY OF THE INVENTION

The invention provides a thermosetting heat-resistant powder coating composition that is particularly useful for coating high temperature stacks, mufflers, manifolds, boilers, ovens, furnaces, stove burners, steam lines, heat exchangers, barbeque equipment, cooking utensils and other parts that are subjected to high temperatures. The coating composition of this invention provides a coating with excellent heat resistant characteristics and in particular is resistant to adhesive failure such as delamination and flake off when exposed to high temperatures.

The powder coating composition of the present invention comprises:

1) at least one polysiloxane, preferably a hydroxy-functional polysiloxane; and,

2) at least one high temperature matrix material, preferably a low melting inorganic glass, that softens and exhibits some flow in the temperature range in which the polysiloxane resin undergoes rapid shrinkage and embrittlement.

Articles comprising one or more layers of these coating materials are also included in this invention.

### DETAILED DESCRIPTION OF THE INVENTION

Herein, unless otherwise noted, all percentages are by weight. The total of the binder resins, i.e., the polysiloxane resin plus any other type of binder resin is expressed as 100% by weight and all other components of the coating powder composition such as the matrix materials, fillers, pigments, flow control agents, cure catalyst, etc. are expressed as % by weight based on 100% by weight resin. Polysiloxane resins as used herein are also often referred to as silicones or polysiloxanes or polysiloxane polymers.

The present invention is based upon the discovery that the heat-resistant properties of polysiloxane based powder coatings can be improved by incorporating into the coating composition a high temperature matrix material which softens and exhibits some degree of flow in the temperature range in which polysiloxane coatings suffer loss of their organic components and undergo rapid shrinkage and embrittlement. The high temperature matrix material is designed to fill voids in the coating left by loss of their organic components and thereby reduce shrinkage and stop cracks from propagating in the film, making the coating resistant to adhesive failure, such as peeling off, flaking and delamination, from the substrate at high temperatures.

While “high temperature” is a relative term, the coating powders of the present invention are intended to withstand temperatures whereat most organic components, including organic moieties of the polysiloxane resin, burn away. Accordingly, it is a desire that coatings of the present invention withstand, for example, temperatures of 550° C. (1022° F.) and upward, although end use temperatures and other requirements of the coating powder may vary according to the particular coating application.

The coating powders of the present invention provide coatings that have the aforementioned desirable characteristics. The coatings of this invention have improved heat-resistant and delamination-resistant characteristics and outperform existing products currently available for use as heat-resistant coatings.

By “improved heat-resistant characteristics”, it is meant that a coating formed on a substrate from the coating powder of this invention will retain its adhesion after exposure to temperatures of 550° C. or above.

By “improved delamination-resistant characteristics”, it is meant that the coating formed on a substrate from the coating powder of this invention will not flake or peel off the substrate after exposure to 550° C. or above.

The coatings of this invention are particularly useful on articles which are subjected to elevated temperatures including stacks, mufflers, manifolds, boilers, ovens, furnaces, steam lines, heat exchangers, barbeque equipment, cooking utensils and other articles which are subject to elevated temperature.

It is known that when exposed to air at temperatures above about 350° C., most organic coatings are consumed in a matter of minutes. Polysiloxane-based powder coatings, even though they perform better at higher temperatures, are also affected because the polysiloxane resins which go into such coatings contain organic moieties. As the organic moieties of the polysiloxane resins oxidize away, the polysiloxane resin shrinks; and stresses build up in the coatings that are relieved by cracking and peeling.

The compositions of the present invention preferably contain high amounts of polysiloxane resin in the resin system. A resin system which is essentially all polysiloxane, as in accordance with the preferred embodiment of this invention, provides stability at the highest temperatures, having minimal amounts of organic moieties and therefore minimal shrinkage as the organic moieties burn away. The organic fraction of typical polysiloxane resins used for powder coatings ranges from about 30 to about 60% of the total resin weight.

Accordingly, in the preferred embodiment of the present invention the compositions of this invention have a resin or binder system which comprises essentially 100% by weight of a polysiloxane resin or blend of polysiloxane resins. At temperatures of about 140-260° C., polysiloxane resins will self-condense to form a crosslinked network.

The coating powders of this invention can also contain lesser amounts of polysiloxane resins depending on the particular application. When lesser amounts are used, the coating powders of this invention typically comprise from about 10 to 100% by weight polysiloxane resin based on the total weight of the binder, preferably from about 30 to 100%, and most preferably from about 40 to 100% by weight. If the polysiloxane level is below 10% by weight, the coating may have inadequate heat-resistance.

The polysiloxane resins suitable for use herein can be any alkyl and/or aryl substituted polysiloxane, copolymer, blend or mixture thereof, the alkyl substitution preferably selected from short chain alkyl groups of 1 to 4 carbon atoms, more preferably 1 to 3 carbon atoms, and most preferably methyl, propyl and the aryl substitution most preferably comprising phenyl groups. For good heat-resistance, methyl and phenyl groups are the organic moieties of choice. Generally the more methyl groups, , the less coating shrinkage is observed on heat exposure. For forming powder coatings, the polysiloxane resins should be solid at room temperature and preferably have a Tg (glass transition temperature) of at least 45° C. and be able to be melt processed at temperatures less than 200° C. Examples of such polysiloxane resins are phenylsilicone Silres® 601 or methylsilicone Silres® MK, available from Wacker Silicone, Adrien, Mich., and proplyphenyl Z-6018 or methylphenylsilicone 6-2230 available from Dow Corning, etc. Suitable resins are also described in U.S. Pat. Nos. 3,585, 065, 4,107,148, 3,170,890 and 4,879,344, incorporated herein by reference.

The organic moieties on polysiloxane resins can also bear organic functional groups, such as COOH, NCO, amine, epoxy functional groups, etc,. such as are disclosed in U.S. Pat. Nos. 6,046,276, 6,274,672, 6,376,607, 5,280,098 and 5,516,858, incorporated herein by reference, for added mechanical properties and enhanced reactivity with the film forming resins used in the resin system.

Preferably, for added heat resistance, good melt processability at temperatures less than 200° C. and susceptibility to undergo crosslinking reactions, a hydroxyl-functional polysiloxane is used, with the hydroxyl-functionality up to about 10% by weight, preferably in a range from about 0.5% by weight to about 10.0% by weight, based on the total polysiloxane solids. Polysiloxane polymers may include subunits silicon atoms bearing one, two or three organic groups from the following set: methyl, ethyl, propyl and phenyl. Examples of commercially available hydroxyl-functional polysiloxanes include Dow Corning® 1-0543, Dow Corning® 6-2230 and Dow Corning® Z-6018 from Dow Corning (Midland, Mich.); Wacker Silres® MK and Wacker Silres® 601, 602, 602, 604 and 605 from Wacker Silicone Corp., (Adrien, Mich.); General Electric SR-355 from General Electric (Waterford, N.Y.); and PDS-9931 from Gelest, Inc., (Tullytown, Pa.). Other suitable polysiloxane-based polymers include those described in U.S. Pat. No. 4,107,148 (Fujiyoshi et al.) and U.S. Pat. No. 4,879,344 (Woo et al.), incorporated herein by reference.

The powder coating compositions of this invention may also contain, if at all present, one or more resins commonly used in such coatings and well known in the art. These resins, if used, will make up the balance of the binder system. Such resins include organic polymers and oligomers including those based on epoxy resins, polyester resins, acrylic resins and/or urethane resins, such as those described in U.S. Pat. No. 5,998,560, incorporated herein by reference. When acrylic polymers are present in the powder coating composition, they may be glycidyl, hydroxy or carboxylic acid-functional acrylic polymers.

The most critical component of the present compositions is the high temperature matrix material. As already mentioned above, these materials provide the desired resistance to adhesive failure when the coatings produced from the coating powders of this invention are subjected to high temperatures. By “high temperature matrix material”, it is meant a hard or rubbery solid at room temperature, either amorphous or crystalline, or a combination of the two, that do not soften enough to undergo flow at temperatures up to 260° C. (i.e., at normal polysiloxane based powder processing and cure temperatures), but which soften in the temperature range in which polysiloxane resins suffer loss of their organic components and undergo rapid shrinkage and embrittlement. Preferably, the matrix material softens and exhibits some degree of flow at temperatures between about 300° C. and 700° C., and especially between 375° C. and 550° C. Low-melting inorganic glasses are particularly useful high temperature matrix materials.

Preferably, the high temperature matrix material is present in the range from about 0.5 to 90% by weight of the polymer content of the composition, more preferably from about 5 to 70% by weight, and most preferably from about 10 to 50% weight, to increase the resistance to adhesive failure when exposed to high temperature. It is understood that these are general guidelines and the exact weight % of matrix material particles will depend on the specific gravity of the particles, the degree of heat resistance desired, and the other components of the powder coating composition.

If the content of the high temperature matrix material is too low, the coating may have inadequate resistance to delamination. When it is too high, flow is retarded and the coating becomes rough.

Of special interest are inorganic glasses, including those composed of metal oxides, fluorides, chlorides, and the like and mixtures of these constituents. Of more particular interest are the low-melting glasses composed primarily of mixtures of oxides of silicon, sodium and potassium and boron. Examples of suitable glasses are found in U.S. Pat. Nos. 4,983,550 and U.S. Pat. No. 5,217,928, incorporated herein by reference.

A useful feature of these high temperature matrix materials is that they are convenient to introduce into a coating powder. The high temperature matrix material particles can be supplied to the coating-manufacturing process in any shape or size. To provide convenience in use, it is preferred that the particles be below about 100 microns in their largest dimension, so that they will not induce roughness in the coating and so that they can be minutely dispersed. The upper limit of the size of the matrix particles is dependent on the intended thickness of the final coating in that the particles should have a size less than the coating thickness. Most powder coatings are designed to be applied at a dry film thickness of about 50 microns. Thus, in most applications, the particles should have a maximum size in their largest dimension of less than about 50 microns, preferably 40 microns.

It is further preferred that the particles be generally spheroidal, and it is especially preferred that they have a specific gravity less than about 2. The term “spheroidal” or “spheroids” as used herein means generally spherical in shape. More specifically, the term means filler materials that contain less than 25% particle agglomerates or fractured particles containing sharp or rough edges, so that the particles are not significantly altered in further processing.

Examples of suitable matrix materials are inorganic glass particles selected from hollow spheroids, solid spheroids, fibers, and/or glass frit. Inorganic crystalline particles, such as barium zirconium fluoride, BaZr₂F₁₀ may also be used as the matrix material.

Examples of especially-preferred high-temperature matrix materials include Q-Cell® 7040S, Q-Cell® 5070S and Q-Cell® 6042S glass particles, provided by the PQ corporation of Valley Forge, Pa. Characteristics of these glasses are listed in Table 1 below.

TABLE 1

| | | Softening | | Specific |
|---|---|---|---|---|
| Glass | Composition | Temperature | Form | Gravity |
| Q-Cell 7040S | Primarily Oxides | 450-500° C. | Hollow, | 0.4 |
| | of Si, Na, K, B | | Spherical | |
| Q-Cell 6042S | Primarily Oxides | 400-450° C. | Hollow, | 0.4 |
| | of Si, Na, K, B | | Spherical | |
| Q-Cell 5070S | Primarily Oxides | 450-500° C. | Hollow, | 0.7 |
| | of Si, Na, K, B | | Spherical | |

Reinforcing fillers (which are different from the matrix materials mentioned previously) may be added to improve the properties or performance of coatings based on combinations of polysiloxane resins and high temperature matrix materials. These reinforcing fillers are well-known in the art and include needle-like materials such as wollastonite (calcium silicate), plate-like materials such as micas (potassium aluminum silicates), fibrous materials such as asbestos, and various man-made fibrous, rod-shaped or plate-like refractory materials including silicate glasses. Glass particles which melt at higher temperatures than the high temperature matrix materials may also be used as reinforcing fillers. Typical examples include Nyad M 400, a wollastonite filler supplied by Nyco Corporation, Willsboro, N.Y.; and Suzorite 325 HK, a phlogopite mica supplied by Suzorite Mica Products, Inc., of Boucherville, Quebec, Canada. Other examples include materials reported in the patent literature referenced herein.

It may be desirable to include high-aspect-ratio fillers such as those described in U.S. Pat. No. 6,248,824, incorporated herein by reference.

Reinforcing materials, if at all present (that is above 0% by weight) are typically included in a range from about 5 to 50% by weight of the polymer content of the composition, preferably from about 10 to 40% by weight. When the reinforcing material level is low, coating resistance to abrasion and physical damage in the as-cured state may be low. When it is too high, flow is reduced and the coating becomes rough.

In addition to the required polysiloxane resins and the high temperature matrix materials and the sometimes desirable reinforcing fillers, the powder coating compositions of this invention may contain other additives that are conventionally used in powder coating compositions and in high use temperature powder coatings. These additives include: adhesion promoters; fillers; pigments; flow and leveling additives; degassing aids; gloss-modifying agents; cratering agents; curing agents; cure catalysts; texturizers; surfactants; organic plasticizers; agents to improve electrostatic application properties; agents to improve corrosion resistance; agents to improve the dry-flow properties of the powder; and the like, as are taught, for example, in U.S. Pat. No. 5,905,104, incorporated by reference herein. Compounds having anti-microbial activity may also be added as is taught in U.S. Pat, No. 6,093,407, also incorporated herein by reference.

While polysiloxane resins self-condense at elevated temperatures to form a crosslinked network, it is often desirable to employ small quantities of a cure catalyst such as stannous octoate, dibutyl tin dilaurate, zinc octoate, zinc acetylacetonate, zinc neodecanoate and their mixtures, so as to achieve rapid gel time. Typically at least about 0.1% by weight of the polymer content of such cure catalyst is employed, up to about 2% by weight.

Flow control agents can be present in the powder-based compositions up to about 3.0% by weight, and preferably from about 0.5% to 1.5% by weight, based on the total polymer content. The flow control agents may include acrylics, polysiloxanes and fluorine-based polymers. Examples of commercially available flow control agents include Resiflow® PL-200 and Clearflow® Z-340. from Estron Chemical, Inc. (Calvert City, Ky.); Mondaflow® 2000 from Monsanto (St. Louis, Mo.); Modarez®. MFP from Synthron, Inc. (Morgantown, N.C.); and BYK® 361 and BYK®. 300 from BYK Chemie (Wallingford, Conn.). Said agents enhance the compositions melt-flow characteristics and help eliminate surface defects.

Degassing agents can be used in the powder-based compositions to assist in the release of gases during the curing process. These materials are typically present in a range from about 0.1% to 5.0% by weight, based on the total polymer content. Examples of a commercially available degassing agents include Uraflow® B from GCA Chemical Corporation (Brandenton, Fla.) and Benzoin from Estron Chemical (Calvert City, Ky.).

It is also often desirable to employ a dry-flow additive, so as to improve dry-flow characteristics of the powder-based compositions. Examples include fumed silica, aluminum oxide and their mixtures. These materials are typically present in a range form about 0.05 to 1% by weight, based on the total polymer content.

If desired, other optional ingredients such as inorganic fillers can be used in combination with the reinforcing fillers already mentioned to provide texture, control gloss, and increase the coatings volume to enhance its economics. Optional other additives such as any of those listed above can also be employed in the usual amounts to further enhance the properties of the compositions.

The powder coatings of this invention, which are solid particulate film-forming mixtures, are prepared by conventional manufacturing techniques used in the powder coating industry. For example, the ingredients used in the powder coating, including the high temperature matrix materials, can be dry blended together and then melt mixed in an extruder, at a temperature sufficient to melt the resin in the mixture (preferably at a temperatures below 200° C. ) and then extruded. The extruded material is then cooled on chill rolls to a solid, broken up and then ground to a fine powder.

Additional ingredients may be blended with the formed powder. This process step is included for example when the additional ingredient may be damaged or rendered useless by the extrusion, chilling, breaking or grinding processes, or when the additional ingredient may damage the equipment used for dry-blending, extrusion, chilling, breaking or grinding processes. The high temperature matrix material is typically added at this step. This is especially appropriate for glass spheres of density less than 2.0.

The high temperature matrix material may also be combined with the coating powder after it is formed by dry blending or in a process known as “bonding.” In this bonding process, the coating powder and the material to be “bonded” with it are dry blended and subjected to heating and impact fusion to join the differing particles. The matrix materials can conveniently be added at this step. In cases where the pre-formed coating powder and the high temperature matrix materials fluidize and charge very differently leading to segregation during application of a blend, “bonding” the blended materials is desirable.

The powder coating compositions of this invention may be applied by electrostatic spray, thermal or flame spraying, or fluidized bed coating methods, all of which are known to those skilled in the art. The coatings may be applied to metallic and/or non-metallic substrates. Following deposition of the powder coating to the desired thickness, the coated substrate is typically heated in the range from about 140° to 260° C., to melt the composition and cause it to flow and cause the powder to cure and bond to the substrate and form a crosslinked polymer matrix. In certain applications, the part to be coated may be pre-heated before the application of the powder, and then either heated after the application of the powder or not. Gas or electrical furnaces are commonly used for various heating steps, but other methods (e.g., microwave) are also known. The powder coatings of this invention provide the formulator with an opportunity to improve heat resistance of the final coating and make heat resistant coatings perform at even higher temperatures than those currently available in the art.

The coatings formed with the powders of this invention provide excellent heat resistant properties and are particularly useful on articles which are subjected to elevated temperatures including stacks, mufflers, manifolds, boilers, ovens, furnaces, steam lines, heat exchangers, barbeque equipment and cooking utensils.

The present invention is further illustrated by, but not limited to, the following examples. All parts and percentages are on a weight basis unless otherwise indicated.

### EXAMPLES

### Comparative Examples 1-3

Comparative Examples 1 through 3 are outside the scope of the invention and are intended to illustrate the limitations of known technology.

### Comparative Example 1

This example demonstrates that polysiloxane resins by themselves do not form delamination-resistant coatings.

Coating Powder CEx. 1 was prepared by blending 1000 g of Silres 604, 10 grams of Resiflow PL-200 and 5 grams of benzoin. The blended materials were passed through a twin-screw extruder which melted the resin and further blended the mixture. The extrudate was solidified by passing between chilled rollers, then broken into flakes. The flakes were mixed with 10.0 g HDKN20 silica dry flow additive and ground through a hammer mill. The resulting powder was passed through an 80-mesh sieve to remove coarse particles to form Coating Powder CEx. 1.

Powder CEx. 1 was electrostatically applied to a cold-rolled steel panel 0.032″ thick and baked in a 260° C. oven for 15 minutes to form a coating. After cooling to room temperature, the delamination-resistance of the coating was tested by heating the coated panel from the back side to red heat (approximately 730° C.) in a propane/air flame for five minutes then allowing it to cool. Upon cooling, the tested coating suffered flaking and delamination.

### Comparative Example 2

This example demonstrates that low levels of reinforcing fillers do not render a polysiloxane-resin film delamination resistant.

Coating Powder CEx. 2 was prepared by blending 1000 g of Silres 604 resin, 10 grams of Resiflow PL-200, 5 grams of benzoin, 75 g of Nyad M400 filler and 75 g of 325HK mica filler. The blended materials were passed through a twin-screw extruder which melted the resin and further blended the mixture. The extrudate was solidified by passing between chilled rollers, then broken into flakes. The flakes were mixed with 10.6 g of HDKN20 silica dry flow additive and ground through a hammer mill. The resulting powder was passed through an 80-mesh sieve to remove coarse particles to produce Coating Powder CEx. 2.

The resulting Coating Powder CEx. 2 was electrostatically applied to a cold-rolled steel panel 0.032″ thick and baked in a 260° C. oven for 15 minutes to form a coating. After cooling to room temperature, the delamination-resistance of the coating was tested by heating the coated panel from the back side to red heat (approximately 730° C.) in a propane/air flame for five minutes then allowing it to cool. Upon cooling, the tested coating suffered flaking and delamination.

### Comparative Example 3

This example demonstrates that high levels of reinforcing fillers do not render a polysiloxane-based coating delamination resistant. Coating Powder CEx. 3 was prepared by blending 1000 g of Silres 604 resin, 10 grams of Resiflow PL-200, 5 grams of benzoin, 300 g of Nyad M400 filler and 300 g of 325HK mica filler. The blended materials were passed through a twin-screw extruder which melted the resin and further blended the mixture. The extrudate was solidified by passing between chilled rollers, and broken into flakes. The flakes were mixed with 16.1 g of HDKN20 silica dry flow additive and ground through a hammer mill. The resulting powder was passed through an 80-mesh sieve to remove coarse particles.

The resulting Coating Powder CEx. 3 was electrostatically applied to a cold-rolled steel panel 0.032″ thick and baked in a 260° C. oven for 15 minutes to form a coating. After cooling to room temperature, the delamination-resistance of the coating was tested by heating the coated panel from the back side to red heat (approximately 730° C.) in a propane/air flame for five minutes then allowing it to cool. Upon cooling, the tested coating suffered flaking and delamination.

### Examples 1 and 2

These examples are within the scope of the invention.

### Example 1

This example demonstrates that a combination of a polysiloxane resin and a low-melting glass produces a delamination-resistant coating.

Coating Powder Ex. 1 was prepared by dry blending 1000 g of Silres 604, 10 grams of Resiflow PL-200 and 5 grams of benzoin. The blended materials were passed through a twin-screw extruder which melted the resin and further blended the mixture. The extrudate was solidified by passing between chilled rollers, then broken into flakes. The flakes were mixed with 10.1 g HDKN20 silica dry flow additive and ground through a hammer mill. The resulting powder was passed through an 80-mesh sieve to remove coarse particles to form a coating powder.

A sample of 80 grams of coating powder prepared above was blended with 20 grams of Q-Cell 7040S glass balloons to form Powder Ex. 1. Powder Ex. 1 was electrostatically applied to a cold-rolled steel panel 0.032″ thick and baked in a 260° C. oven for 15 minutes to form a coating.

After cooling to room temperature, the panel was tested was subjected to solvent resistance, pencil hardness and crosshatch adhesion testing. The delamination-resistance of the coating was tested by heating the coated panel from the back side to red heat (approximately 730° C.) in a propane/air flame for five minutes then allowing it to cool. Upon cooling, the coating did not suffer flaking or delamination. Performance is listed in Table 2.

### Example 2

This example demonstrates a delamination-resistant coating with improved physical properties.

Coating Powder Ex. 2 was prepared by blending 1000 g of Silres 604 resin, 10 grams of Resiflow PL-200, 5 grams of benzoin, 75 g of Nyad M400 filler and 75 g of 325HK mica filler. The ingredients were dry-blended, then passed though a twin-screw extruder which melted the resin and further blended the mixture. The extrudate was solidified by passing between chilled rollers, and broken into flakes. The flakes were mixed with 11.6 g of HDKN20 silica and ground through a hammer mill. The resulting powder was passed through an 80-mesh sieve to remove coarse particles, giving a coating powder.

A sample of 80 g of the resulting coating powder prepared above was dry blended with 20 g of Q-Cell 7040S glass balloons to form Coating Powder Ex. 2. Coating Powder Ex. 2 was electrostatically applied to a cold-rolled steel panel 0.032″ thick and baked in a 260° C. oven for 15 minutes to form a coating.

After cooling to room temperature, the panel was tested was subjected to crosshatch adhesion testing, and found to be improved over Coating Ex. 1, which was not reinforced. The delamination-resistance of the coating was tested by heating the coated panel from the back side to red heat (approximately 730° C.) in a propane/air flame for five minutes then allowing it to cool. Upon cooling, the coating did not suffer flaking or delamination. Performance is listed in Table 3.

TABLE 2

| Test Methods | Coating Ex. 1 | Coating Ex. 2 |
|---|---|---|
| Crosshatch Adhesion¹ | 0 B | 3 B |
| Delamination Resistance | Yes | Yes |

Table Footnotes:
¹Crosshatch Adhesion was tested at a spacing of 2 mm, using the procedure described in ASTM D3359 Method B. Results are judged on a scale from 0 (removal > 65%) to 5 (no coating removal).

The conclusion from these examples is that the high temperature matrix material significantly increases the heat resistance and delamination resistance of the coating formed from a powder coating composition of this invention.

What is claimed is:

1. A powder coating composition for producing a high temperature resistant coating, comprising
(a) at least one polysiloxane; and
(b) from about 0.01 to 90% by weight, based on the total weight of the polymer content, of at least one high temperature matrix material that softens and exhibits some flow in the range from about 300 to 700° C.

2. The composition of claim 1 wherein the matrix material comprises at least 10% of the polymer content.

3. The composition of claim 2 wherein the coating formed from the powder coating composition does not delaminate after exposure to temperatures of at least 550° C.

4. The composition of claim 2 wherein the composition further comprises from about 5 to 50% by weight of the polymer content of a reinforcing filler.

5. The composition of claim 2 wherein the matrix material is inorganic glass particles selected from the group consisting of hollow spheroids, solid spheroids, fibers, and frit.

6. The composition of claim 5 wherein the high temperature matrix material is selected from inorganic glass particles with a specific gravity less than 2.

7. The powder of claim 1, wherein the matrix material is selected from inorganic crystalline particles.

8. A process for making a heat-resistant powder coating composition, comprising:
(a) forming the powder coating of claim 1, less the high temperature matrix material, by standard melt-mixing processes; and
(b) blending the matrix material with the powder.

9. A process for making a heat resistant powder coating, comprising:
(a) blending the matrix material with the polysiloxane prior to melt mixing; and
(b) transforming the melt mixed material to a powder coating using standard powder manufacturing processes.

10. An article having coated and cured thereon, at least one coating layer formed from the powder coating composition of claim 1.

11 The article of claim 10 wherein the coating has a thickness of at least about 40 microns.
